(19) United States
(12) Patent Application Publication
(10) Pub. No.: US 2026/0257178 A1
(43) Pub. Date: Sep. 3, 2026

(54) SYSTEMS AND DEVICES FOR FILTERING BIOLOGICAL PRODUCTS AND METHODS OF USING THE SAME

(71) Applicant: Sanofi Pasteur Inc., Swiftwater, PA (US)

(72) Inventors: John Michael D'Orsi, III, Stroudsburg, PA (US); Chad David Hauze, Hellertown, PA (US); Peer Christian Wespestad, Bethlehem, PA (US)

(21) Appl. No.: 19/489,207

(22) PCT Filed: May 30, 2024
(86) PCT No.: PCT/US2024/031589

§ 371 Date: Dec. 1, 2025

Related U.S. Application Data
(60) Provisional application No. 63/470,568, filed on Jun. 2, 2023.

(51) Int. Cl. B01D 61/58

(52) U.S. Cl. CPC B01D 61/58; B01D 2313/06; B01D 2313/18; B01D 2313/243; B01D 2313/58; B01D 2313/60; B01D 2313/701; B01D 2313/702; B01D 2313/903

(57) ABSTRACT

Systems and devices for filtering biological products and methods of using the same are provided. A filtration system can include a filtration skid configured to be adapted for engagement with components of a single-use assembly for facilitating one or more unit operations of a continuous filtering process for the one or more biological products. The filtration skid can include a pump cart and a filtration cart. The filtration cart can include a first filter support assembly configured to support a first filtering flow channel and a second filter support assembly configured to support a second filtering flow channel.

### FIELD OF THE DISCLOSURE

The present application claims priority under 35 USC 119 to U.S. Provisional Application No. 63/470,568, which was filed on Jun. 2, 2023, the entire contents of which is incorporated by reference in its entirety.

The present disclosure relates generally to the field of biomanufacturing and bioprocessing. More specifically, the present disclosure relates to systems and devices (e.g., manufacturing systems and/or devices using filtration skids) for filtering biological products and methods of using the same.

### BACKGROUND

Rapid advances in upstream processes for biologics production have left downstream processing as a bottleneck in the manufacturing scheme. Accordingly, manufacturers are pursuing continuous downstream process development to increase efficiency and flexibility, reduce footprint and cost of goods, and improve product consistency and quality. However, the implementation of continuous downstream operations is limited due to a number of factors, such as incompatible downstream unit operations (depth filtration, sterile filtration, or viral filtration), limited automation, limited operation range, large equipment size, increased service and maintenance, cost, and so forth. Thus, systems and devices for filtering biological products and methods of using the same which address the foregoing, and other, needs are desired.

### BRIEF DESCRIPTION OF THE DRAWINGS

The foregoing features of the present disclosure will be apparent from the following detailed description of the present disclosure, taken in connection with the accompanying drawings, in which:

FIG. 1 is a diagram illustrating an example filtration system of the present disclosure;

FIGS. 2A-2C are perspective views (FIGS. 2A-2B) and a diagram (FIG. 2C) illustrating an example filtration skid disclosed herein;

FIG. 3 is a diagram illustrating an example product pathway with a filtration system disclosed herein;

FIG. 4 is a flowchart illustrating continuous filtering process steps carried out by a filtration system of the present disclosure;

FIGS. 5A-5E are flowcharts illustrating example continuous filtering process steps carried out by a filtration system of the present disclosure;

FIGS. 6A-6C are tables illustrating example Point of Fill Filtration (PoFF) process parameters;

FIG. 7 is a table illustrating example PoFF cart dispense global parameters;

FIGS. 8A and 8B are tables illustrating example PoFF cart dispense recipe parameters for an example vaccine;

FIGS. 9A and 9B are tables illustrating example PoFF cart dispense recipe parameters for another example vaccine;

FIGS. 10A and 10B are tables illustrating example PoFF cart dispense recipe parameters for another example vaccine;

FIG. 11 is a diagram of an example computing device that can be used to perform one or more steps of the methods provided by example embodiments; and

FIG. 12 is a diagram illustrating computer hardware and network components on which a system can be implemented.

### DETAILED DESCRIPTION

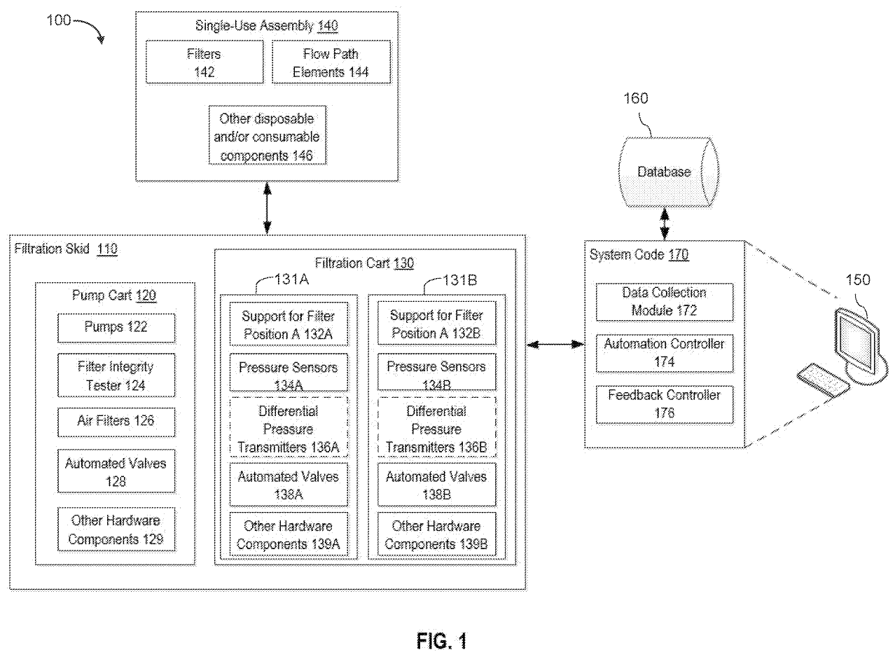

The present disclosure relates to systems and devices for filtering biological products and methods of using the same. Example systems and methods are described in detail below in connection with FIGS. 1-12.

Continuous manufacturing is common in industries such as petrochemical and food production. However, it has not been widely implemented in the biopharmaceutical industry. Because the technological needs for upstream and downstream development in biopharmaceuticals are different than those of other industries, the experience with continuous downstream operations is limited. There remains a need for a system that can accommodate different unit operations to provide continuous filtering processing, which provides automation of the filtering process, wetting, testing, and conditioning, steady state operation, flexibility and mobility, high-volumetric productivity, streamlined process flow, low-cycle times, and/or reduced capital cost.

Embodiments of the present disclosure provide a filtration system (e.g., a PoFF system) to perform continuous and automatic filtering processes. The filtration system can include a filtration skid (e.g., PoFF skid) and one or more single-use assemblies. The filtration skid can be assembled with different single-use assemblies to provide a biological product pathway between one or more biological product tanks and one or more fillers for filling a product container. The filtration skid has the capability of performing various filtration functions (e.g., sterile filtration, depth filtration, viral filtration, or the like) and in-line filter integrity testing to support biological product filling at different locations (e.g., different rooms in a biomanufacturing facility at the same or different floors). The filtering operations using the filtration skid can be automated and controlled by one or more automation recipes.

The filtration skid can allow a continuous filtering process by using a plurality of filter support assemblies. Each filter support assembly can support at least one filtering flow channel having a filter. In some embodiments, the filter support assemblies can allow the filtering flow channels to be switchable, replaceable, and/or simultaneously operable. For example, if a filter support assembly for one filtering flow channel is occupied (e.g., for processing biological products, such as conditioning/reconditioning a filter, filtering and dispensing biological product to a filter or for processing buffer flow, such as wetting a filter or the like), while the filter support assembly is processing buffer flow or biological products, another filter support assembly can be prepared (e.g., initializing/adjusting process parameters) to support an additional filtering flow channel to perform the same processing step for the same unit operation or perform a different processing step for a different unit operation. If one filter support assembly for a filtering flow channel is not operational, the filtering flow channel can be automatically switched to another filter support assembly for processing. If a filtering flow channel fails to operate, another filtering flow channel can replace the failed filtering flow channel by coupling to another filter support assembly. In some embodiments, the multiple filter support assemblies can allow multiple filtering flow channels to operate simultaneously. In such a way, instead of batch processing, the filtration skid(s) can allow continuous filtering processing between the biological product tank(s) and filler(s). It should be understood that the number of the filter support assemblies can be more than two to allow more than two filtering flow channels to be switchable, replaceable, and/or to operate simultaneously. In some embodiments, a single physical structure may comprise two or more filter support assemblies.

In some embodiments, the filtration system can further include a computing device (e.g., a computer, a server, mobile device, or other electronic device) to control the filtration skid. The computing device can include a memory storing one or more instructions (e.g., automation recipes) and a processor configured to or programmed to execute the one or more instructions stored in the memory to automatically perform a continuous filter process, automatically control, monitor and adjust process parameters of the filtration skid. Example process parameters can include flow rates, volumes, temperatures, maximum operating differential pressures, maximum filter contact time, maximum filter contact volumes, minimum batch volume per filter, downtime for a reconditioning, or the like. The filtration skid allows the continuous filtering process to be automated by the computing device. The filtration skid can include automated valves, sensors, transmitters, and/or other hardware components that can be automatically controlled by the computing device. In some embodiments, the filtration skid can detect data associated with process parameters for filtering flow channels, send the data to the computing device for further processing, receive instructions (e.g., automation recipes, user inputs, or the like) from the computing device, adjust operating parameters associated with hardware components of the filtration skid and provide feedback to the computing device for further or future analysis. For example, the computing device can process the data received from the filtration skid and compare the data with validated limits and/or thresholds determined by regulations, safety requirements, biological product requirements, or the like. If the detected data does not satisfy the validated limits and/or thresholds, the computing device can determine (e.g., generate) instructions to adjust the operating parameters of hardware components of the filtration skid. The filtration skid can send a feedback (e.g., updating data, collecting new data using the adjusted operating parameters) to the computing device for further or future analysis.

In some embodiments, the filtration system can perform a continuous filtering process using a filtration skid having a first filter support assembly and a second filter support assembly. For example, the filtration system can initialize the filtration skid and a single-use assembly using an automation recipe. The single-use assembly can include a plurality of filters. The filtration system can wet a first filter of the plurality of filters with buffer. The first filter can be coupled (e.g., connected, attached, mounted or the like) to the first filter support assembly. The filtration system can condition the first filter with a biological product. The filtration system can dispense the biological product to a first filler after passing through the first filter while wetting the second filter with the buffer. The first filter can receive the filtered biological product. The second filter can be coupled to the second filter support assembly. The filtration system can condition the second filter with the same biological product or a different biological product, in some embodiments, while dispensing the biological product to the first filler. The filtration system can dispense the same biological product or a different biological product to a second filler after passing through the second filter while wetting a third filter with the buffer. The process can be repeated up to four filters or more than four filters based on requirements for different unit operations. In such way, the biological products can be filtered in a continuous manner. In some embodiments, the filtration system can support multiple product tanks having the same biological product. The filtration system can also include only one filler and a common outlet such that the filtered biological product can be dispensed to the filler via the common outlet. The parallel activities can process the biological product through one filter while preparing another filter. For example, the first filler and the second filler are the same filler. In some embodiments, the filtration system can include multiple fillers and multiple outlets, each outlet corresponding to a respective filler. For example, the first and second fillers are different fillers. In some embodiments, the filtration system can include multiple fillers sharing a common outlet. In some embodiments, the filtration system can automatically adjust parameters of the first filter support assembly and the second filter support assembly to switch a biological product from one filtering flow channel to another filtering flow channel.

In some embodiments, the filtration skid can include a pump cart and a filtration cart. The pump cart can include a biological product pump and a buffer pump (e.g., peristaltic pumps), a filter integrity tester, air filters (e.g., pharmaceutical air filters), automated valves (e.g., automated pinch valves), pressure sensors, flow transmitters, and/or other hardware. The filtration cart can include two or more filter support assemblies. An example filter support assembly can include a support (e.g., a holder, a rigid casing, or housing) configured to support (via coupling, connecting, mounting, assembling, or the like) a filter, automated valves (e.g., automated pinch valves), pressure sensors and/or transmitters (e.g., differential pressure transmitters). In some embodiments, the filtration skid can include only pressure sensors or only differential pressure transmitters. In some embodiments, a pressure sensor can be coupled (e.g., connecting, mounting, assembling, electrically coupling, or the like) to an upstream flow path to detect upstream pressure of a fluid flow entering a filter, and another pressure sensor can be coupled (e.g., connecting, mounting, assembling, electrically coupling, or the like) to a downstream flow path to detect downstream pressure to the fluid flow exiting the filter. The upstream pressure and the downstream pressure from this pair of the pressure sensors can be used to calculate a differential pressure. In some embodiments, a differential pressure transmitter can be coupled (e.g., connecting, mounting, assembling, electrically coupling, or the like) to both upstream and downstream flow paths to detect a differential pressure between an upstream fluid flow entering a filter and the downstream fluid flow exiting the filter. In some embodiments, the filter support assemblies are identical or very similar. In some embodiments, the filter support assemblies can be different. For example, one filter support assembly can include more hardware components (e.g., valves, sensors, or other suitable hardware components) than another filter support assembly.

The present disclosure provides several technical benefits, including, but not limited, to one or more of: continuous filtering processing, automatic processing, parallel processing, steady state operation, movable capabilities, reduced overall size of a system/device for biomanufacturing, reduced capital cost, reduced service and maintenance, reduced complexity, simplified equipment qualification, simplified skid manufacturing, and so forth.

As used herein, a “unit operation” refers to a functional step that can be performed in a method of filtering a biological product, or a component of a system used in a process of filtering a biological product. Examples of a unit operation can include methods and/or system components for depth filtration, virus filtration, sterile filtration, filter wetting, conditioning, integrity testing or another suitable functional step that can be performed in a method or a system of filtering a biological product or the like.

As used herein, a “single-use assembly” refers to an assembly providing a collection of consumable and/or disposable components to perform a specific unit operation. Examples of the consumable and/or disposable components can include a plurality of filters and/or filter assemblies, one or more flow path elements (e.g., tubing, fluid conduits, pipelines, manifolds, dispensing transfer line or the like), one or more connectors (e.g., aseptic connectors), one or more chambers, one or more housing, one or more pump heads, one or more sensors, or other suitable disposable and/or consumable components needed for performing a specific unit operation. All components of a single-use assembly can alternatively be made permanent instead of single-use, so far as consistent with the desired applications, which may require, for example the addition of cleaning and/or sterilization systems or steps.

As used herein, a “filtration skid” refers to a three-dimensional solid structure that can act as a platform or support for various single-use assemblies to perform various unit operations described herein. A filtration skid can, if it comprises one or more structures that enable movement (e.g., wheels, rollers, or the like), confer mobility on a filtration system or a portion thereof. A filtration skid can be a single solid structure (e.g., all of the hardware components are mounted on the same cart). A filtration skid can include multiple solid structures. For example, the filtration skid can include a single cart or multiple carts, each having hardware components. All of the hardware components (e.g., pumps, valves, sensors, transmitters, filter integrity testers, air filters, regulators, flowmeters, filter supports configured to support filters, and/or other suitable hardware configured to support single-use assemblies and/or configured to couple with the disposable or consumable components of single-use assemblies) or some of the hardware components of a filtration skid can be designed to support various single-use assemblies for the same or different unit operations. All or some of the hardware components of the filtration skid can be permanently mounted.

As used herein, a “filtering flow channel” refers to part of a single-use assembly as described above. An example of filtering flow channel can include filters (e.g., for the purposes of depth filtration, sterile filtration, viral filtration, etc.), flow path elements, other suitable disposable and/or consumable components associated with one or more unit operations, and/or some combinations thereof.

As used herein, a “filter support assembly” refers to a set of hardware components (e.g., supports, valves, sensors, transmitters, mounting hardware, and/or other suitable hardware components) of the filtration skid to support a filtering flow channel.

As used herein, a “filtration assembly” refers to an assembly having a filtration skid assembled with a single-use assembly for a specific unit operation.

As used herein, “continuous processing” or “continuous filtering process” refers to bioprocessing in which a fluid is continuously fed through at least a part of a filtration assembly for a specific unit operation. A unit operation is continuous if a corresponding filtration assembly is capable of processing a continuous flow input for prolonged periods of time. A continuous unit operation has minimal internal hold-up volume within the corresponding filtration assembly. The output can be continuous or discretized in small packets produced in a cyclic manner. Different unit operations are end-to-end continuous if the integrated (physically connected or coupled) filtration assemblies have zero or minimal hold-up volume in between and/or within the filtration assemblies and/or multiple unit operations.

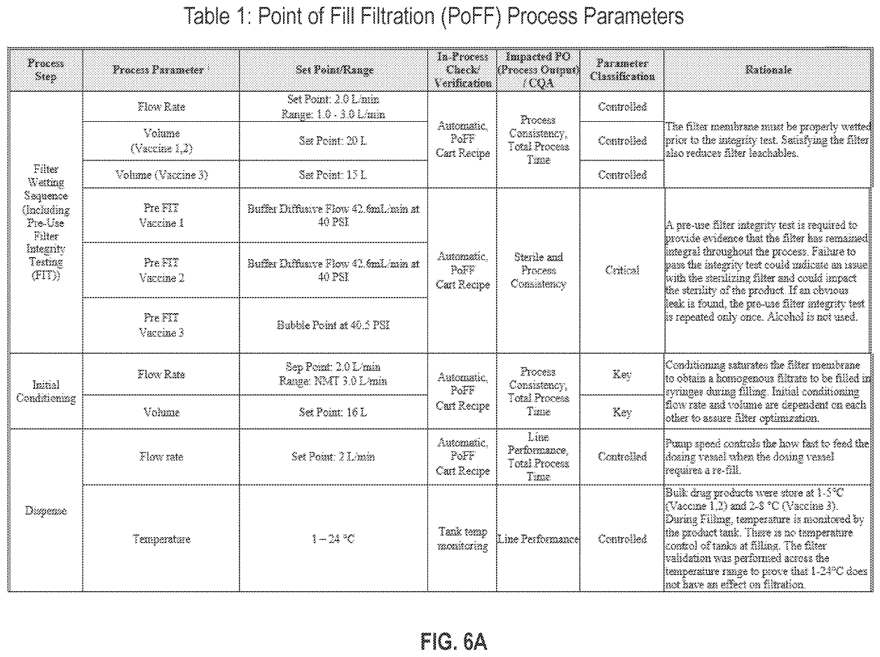

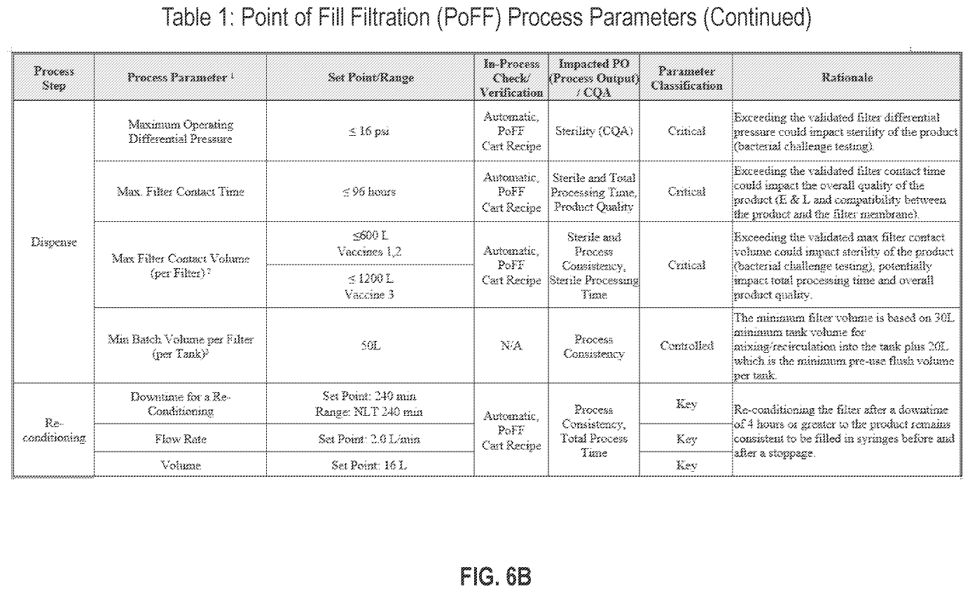

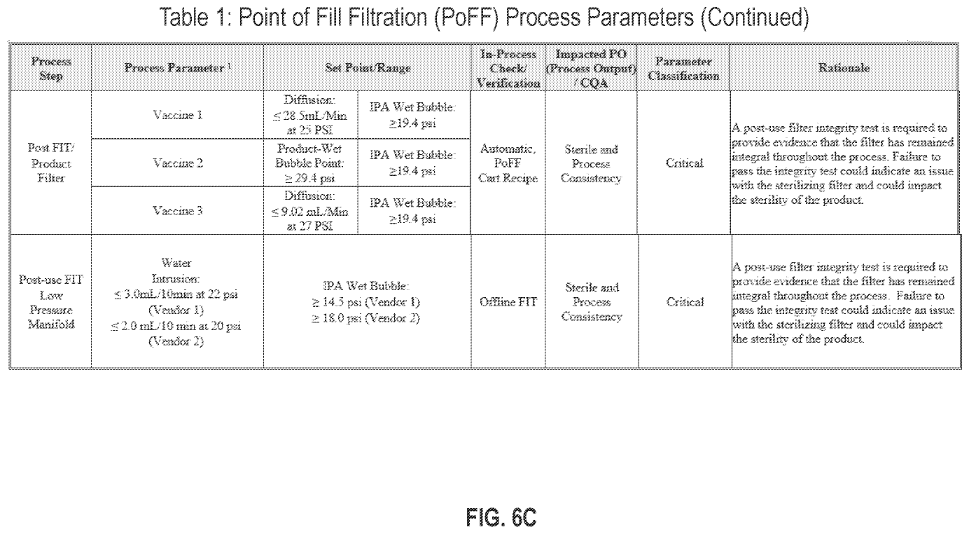

As used herein, an “automation recipe” refers to instructions stored in a memory and executed by a processor to automatically set, monitor and/or adjust process parameters (e.g., flow rates, volumes, temperatures, maximum operating differential pressures, maximum filter contact time, maximum filter contact volumes, minimum batch volume per filter, downtime for a reconditioning, or the like) and operating parameters of a filtration skid for performing a functional step (e.g., wetting filters, conditioning filters, reconditioning filters, dispensing filters, or the like) associated with a unit operation. In some embodiments, the automation recipe can be filter position related. Different automation recipes can be used for different filter positions. Examples of automation recipes, process parameters and operating parameters are shown in FIGS. 6-10.

As used herein, a “biological product” refers to one of a vaccine-based drug substance, a protein-based therapeutic substance, a nucleic acid-based drug substance, and a gene therapy drug substance. The protein-based therapeutic substance can include at least one of a protein, a peptide, an antibody, and an enzyme. The nucleic acid-based drug substance can include at least one of DNA, mRNA, a plasmid, an oligonucleotide, an aptamer, a DNAzyme, an RNA aptamer, an RNA decoy, a microRNA fragment, a small interfering RNA fragment, or other nucleic acid-based materials.

As used herein, the use of the term “about” in conjunction with a numerical value throughout the description refers to within 20% of the stated numerical value.

### Filtration System

Turning to the drawings, FIG. 1 is a diagram illustrating an example filtration system 100 of the present disclosure. The filtration system 100 can include a filtration skid 110 having a pump cart 120 and a filtration cart 130 (which can alternatively be built into a single cart), a single-use assembly 140, a database 160, and a computing device 150 having a system code 170. It should be understood that FIG. 1 is only one potential configuration, and the filtration system 100 of the present disclosure can be implemented using a number of different configurations.

The pump cart 120 can include pumps 122, a filter integrity tester 124, air filters 126, automated valves 128, and/or other hardware components 129.

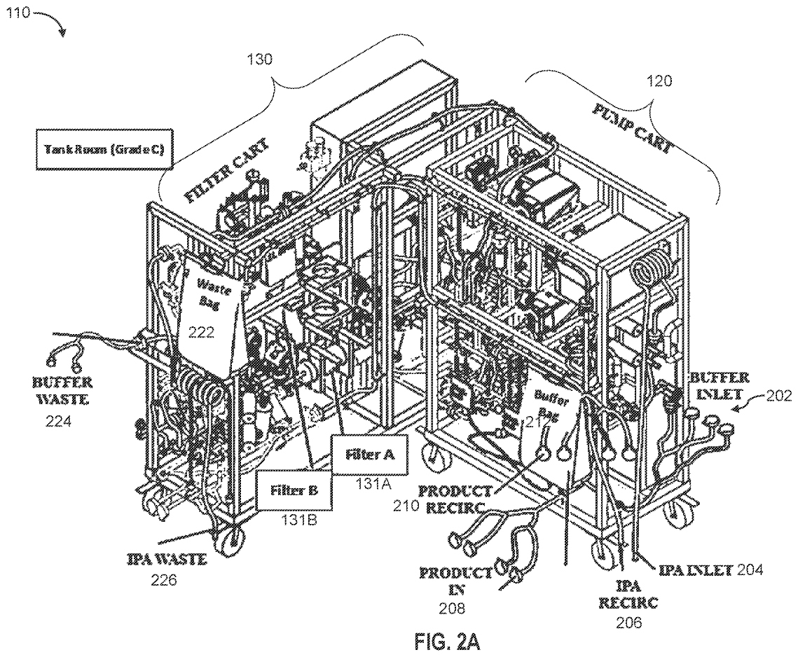

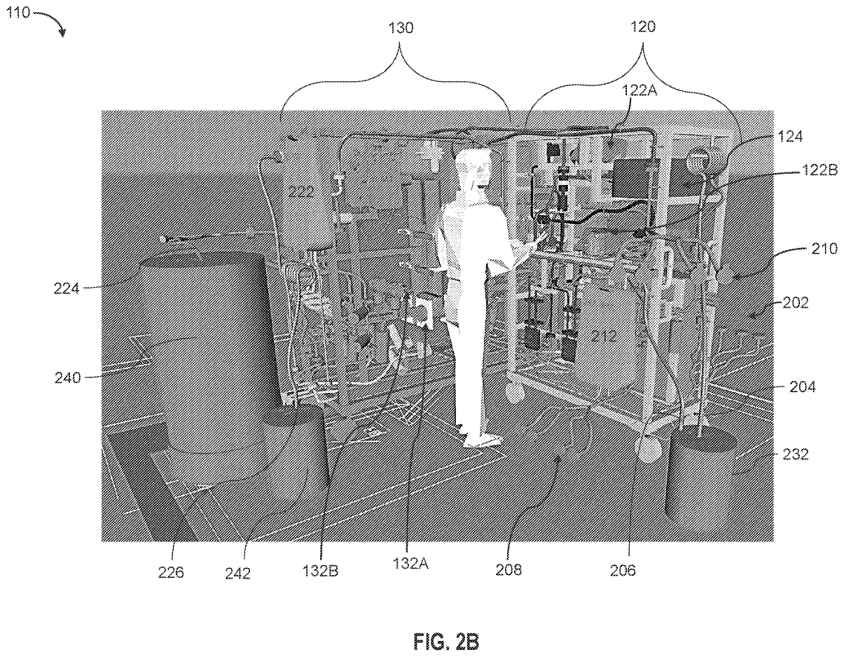

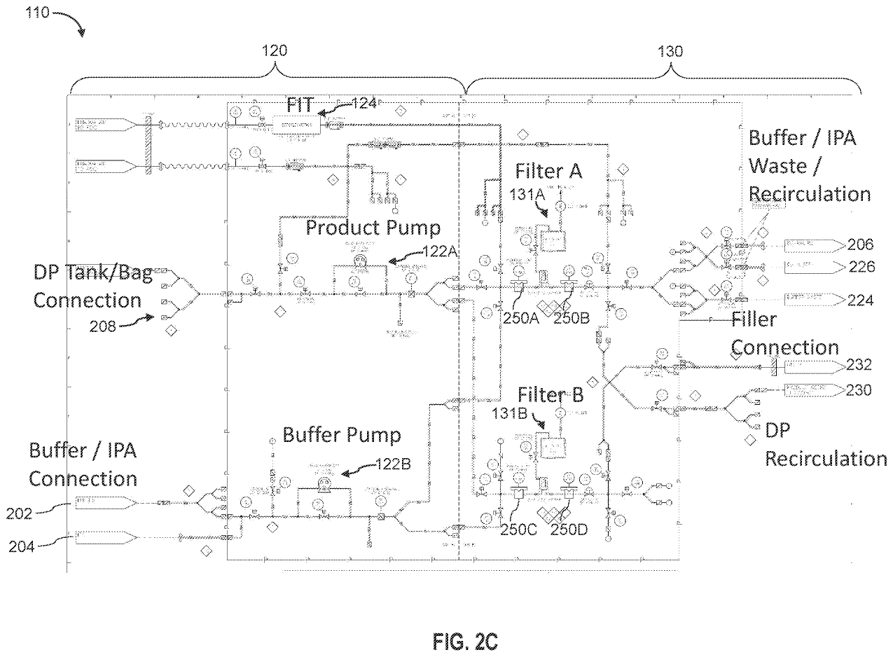

The pumps 122 can include a biological product pump and a buffer pump. The pumps 122 are configured to pump/pressurize a liquid (e.g., buffer) and/or a liquid mixture (e.g., a biological product, a processed biological product, waste or the like). The pumps 122 can be in communication with flow path elements 144 (e.g., tubing, fluid conduits, pipelines, or the like) of the single-use assembly 140 by compressing the flow path elements in such a manner that the liquid mixture is pressurized, thereby causing an output fluid flow from the pumps 122. For example, a buffer pump 122B (shown in FIGS. 2B and 2C) can be configured to pump/pressurize a buffer flowing into the filtration skid 110. A biological product pump 122A (shown in FIGS. 2B and 2C) can be configured to pump/pressurize a biological product flowing into the single-use assembly 140 via the automated valves 128. The pumps 122 can include various types of pumps to pump/pressurize the liquid or the liquid mixture, such as centrifugal pumps, peristaltic pumps, diaphragm pumps, and/or other pump mechanisms to pump/pressurize the liquid and/or liquid mixture.

The filter integrity tester 124 is a device that carries out tests to verify and assure the quality and readiness of the filter membrane based on regulatory requirements or specific application requirements. If a filter fails the tests, the filter is no longer re-usable, and the previously filtered batch may need inspection. In some embodiments, filters can be tested before and after use. If a filter fails before use, it can be removed and replaced with a new unit. If a filter fails after use, there may be a question as to the sterility or quality of the biological product that has been filtered. Additional actions can be taken to determine the condition of the biological product.

Air filters 126 can filter air based on air quality factors applied in a continuous filtering process.

Automated valves 128 can include automated pinch valves that can be automatically controlled by the computing device 150 via the automation controller 174 to facilitate opening and closing the flow of liquid through flow path elements and/or filters without any contact between the liquid and the valve itself. The other hardware components 129 can include pressure sensors, flow transmitters, and other suitable hardware components.

The filtration cart 130 can include a first filter support assembly 131A and a second filter support assembly 132B. The first filter support assembly 131A can include a support 132A (e.g., a holder, a rigid casing, or a filter housing) configured to support a filter at a filter position A, pressure sensors 134A, automated valves 128A, and other hardware components 139A for monitoring, measuring, supporting, coupling, connecting, and/or communicate with the single-use assembly 140 (such as inlets, outlets, recirculation loops, filler connections, or the like). In some embodiments, the pressure sensors 134A can include a pair of pressure sensors. One pressure sensor can be coupled (e.g., connecting, mounting, assembling, electrically coupling, or the like) to an upstream flow path to detect upstream pressure of a fluid flow entering a filter at the filter position A, and the other pressure sensor can be coupled (e.g., connecting, mounting, assembling, electrically coupling, or the like) to a downstream flow path to detect downstream pressure to the fluid flow exiting the filter at the filter position A. The upstream pressure and the downstream pressure from this pair of the pressure sensors can be used to calculate (e.g., via a processor/computing device of the filtration system 100) a differential pressure of the filter at the filter position A. In some embodiments, the first filter support assembly 131A can include one or more differential pressure transmitters 136A to directly measure the differential pressure between the downstream and upstream of the filter at the filter position A. The second filter support assembly 131B can include a support 132B (e.g., a holder, a rigid casing, or a filter housing) configured to support a filter at a filter position B, pressure sensors 134B, automated valves 128B, and other hardware components 139B for monitoring, measuring, supporting, coupling, connecting, and/or communicate with the single-use assembly 140 (such as inlets, outlets, recirculation loops, filler connections or the like). In some embodiments, the pressure sensors 134B can include a pair of pressure sensors. One pressure sensor can be coupled (e.g., connecting, mounting, assembling, electrically coupling, or the like) to an upstream flow path to detect upstream pressure of a fluid flow entering a filter at the filter position B, and the other pressure sensor can be coupled (e.g., connecting, mounting, assembling, electrically coupling, or the like) to a downstream flow path to detect downstream pressure to the fluid flow exiting the filter at the filter position B. The upstream pressure and the downstream pressure from this pair of pressure sensors can be used to calculate (e.g., via a processor/computing device of the filtration system 100) a differential pressure at filter position B. In some embodiments, the second filter support assembly 131B can include one or more differential pressure transmitters 136B to directly measure the differential pressure between the downstream and upstream of the filter at the filter position B.

In some embodiments, each of the filter support assemblies 131A and 131B can support a filter such as a capsule type filter, a flow through filter capsule (e.g., filters arranged in a horizontal direction), “T” style capsule (e.g., filters arranged in a vertical direction), or the like.

The filtration skid 110 can further be coupled with the single-use assembly 140 to perform a specific unit operation. The single-use kit assembly 140 can be easily assembled and/or disassembled with the filtration skid 110. The single-use kit assembly 140 includes filters 142 (e.g., sterilizing grade filters or other suitable filters for depth filtration, sterile filtration, and/or viral filtration), flow path elements 144, and disposable and/or consumable components 146.

The computing device 150 can include, but is not limited to, a computer system, a server, a personal computer, a cloud computing device, a smart phone, or any other suitable device programmed to carry out the processes disclosed herein. Further, the computing device 150 can be embodied as a customized hardware component such as a field-programmable gate array (“FPGA”), an application-specific integrated circuit (“ASIC”), embedded system, or other customized hardware components without departing from the spirit or scope of the present disclosure.

The database 160 includes detection data (e.g., sensor data, transmitter data, valve data, filter integrity testing data, or the like) associated with the filtration skid 110, set point and range values for process parameters (e.g., flow rates, volumes, temperatures, maximum operating differential pressures, maximum filter contact time, maximum filter contact volumes, minimum batch volume per filter, downtime for a reconditioning, or the like), automation recipes associated with various processing steps and unit operations. The database 160 can further include one or more inputs/outputs from/to various components of the filtration system 100 (e.g., inputs/outputs from/to one or more components of the pump cart 120, the filtration cart 130, the single-use assembly 140, inputs/outputs from/to a data collection module 172, an automation controller 174, a feedback controller 176, and/or other components of the filtration system 100).

The system code 170 (non-transitory, computer-readable instructions) stored on a computer-readable medium and executable by the computing device 150 or one or more computer systems. The system code 170 can include various custom-written software modules that carry out the steps/processes discussed herein, and can include, but is not limited to, the data collection module 172, the automation controller 174, the feedback controller 176, and/or other components of the filtration system 100. The system code 170 can be programmed using any suitable programming languages including, but not limited to, C, C++, C#, Java, Javascript, Python, or any other suitable programming language. Additionally, the system code 170 can be distributed across multiple computer systems in communication with each other over a communications network, and/or stored and executed on a cloud computing platform and remotely accessed by a computer system in communication with the cloud platform. The system code 170 can communicate with the database 160, which can be stored on the same computer system as the system code 170, or on one or more other computer systems in communication with the system code 170.

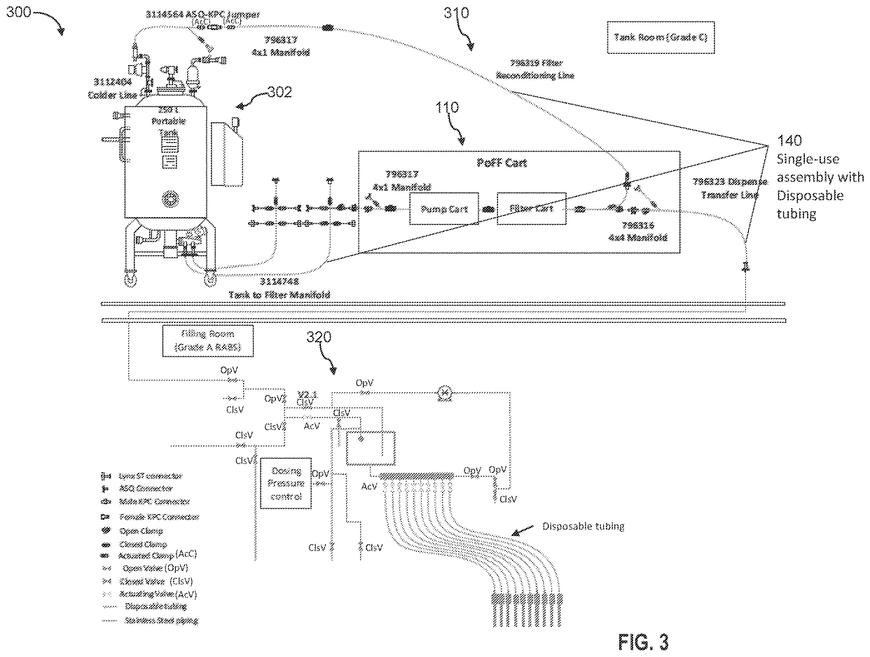

FIGS. 2A-2C illustrate an example filtration skid 110 disclosed herein. The filtration skid 110 includes the pump cart 120 and the filtration cart 130. The pump cart 120 can include a buffer inlet 202, a buffer bag 212, a isopropyl alcohol (IPA) inlet 204 to be connected with the IPA tank 232 (shown in FIG. 2B), an IPA recirculation loop 206, a product inlet 208 to be connected with a biological product tank/bag 302 (shown in FIG. 3), a product recirculation loop 210, a product pump 122A (shown in FIGS. 2B and 2C), a buffer pump 122B (shown in FIGS. 2B and 2C), the filter integrity tester 124 (shown in FIGS. 2B and 2C), a filter support assembly 131A to support a filter at a filter position A, a filter support assembly 131B to support a filter at a filter position B, a buffer waste outlet 224 to be connected with a buffer waste tank 240 (shown in FIG. 2B), an IPA waste outlet 226 to be connected with a IPA waste tank 242 (shown in FIG. 2B), a filler connection 232 (shown in FIG. 2C) to be connected with a filler (not shown), a product recirculation loop 230 (shown in FIG. 2C) for the filter support assembly 131B.

As shown in FIG. 2C, a pressure sensor 250A can be coupled (e.g., connecting, mounting, assembling, electrically coupling, or the like) to an upstream flow path (e.g., from the tank inlet 208 to a filter positioned at the filter position A) to detect upstream pressure of a fluid flow entering the filter, and another pressure sensor 250B can be coupled (e.g., connecting, mounting, assembling, electrically coupling, or the like) to a downstream flow path (e.g., from the filter to the filler connection 232) to detect downstream pressure to the fluid flow exiting the filter at the filter position A. The upstream pressure and the downstream pressure from the pair of pressure sensors 250A, 250B can be used to calculate (e.g., via a processor/computing device of the filtration system 100) a differential pressure of the filter at the filter position A. In some embodiments, the pressure sensors can also be used to detect whether or not the filter at the filter position A is clogged or potentially clogging. If the filtration system 100 determines that the filter at the filter positon A is clogging, the filtration system 100 can determine to switch to another filter, such as a filter at the filter position B. Similarly, a pressure sensor 250C can be coupled (e.g., connecting, mounting, assembling, electrically coupling, or the like) to an upstream flow path (e.g., from the tank inlet 208 to a filter positioned at the filter position B) to detect upstream pressure of a fluid flow entering the filter, and another pressure sensor 250D can be coupled (e.g., connecting, mounting, assembling, electrically coupling, or the like) to a downstream flow path (e.g., from the filter at the filter position B to the filler connection 232) to detect downstream pressure to the fluid flow exiting the filter at the filter position B. The upstream pressure and the downstream pressure from this pair of the pressure sensors 250C, 250D can be used to calculate (e.g., via a processor/computing device of the filtration system 100) a differential pressure of the filter at the filter position B. The filter differential pressure of each filter can impact sterility of the biological products. In some embodiments, the pressure sensors can also be used to detect whether or not the filter at the filter position B is clogged or potentially clogging. If the filtration system 100 determines that the filter at the filter positon B is clogged or potentially clogging, the filtration system 100 can determine to switch to another filter, such as a filter at the filter position A. In some embodiments, the maximum operating differential pressure can be less than or equal to a threshold differential pressure value (e.g., 16 PSI, or other suitable value) at the step of dispensing as further described below. The threshold differential pressure value can be a specific to a particular filter membrane and biological product. In some embodiments, the threshold differential pressure value can be a parameter defined in an automation recipe. In some embodiments, instead of using the pressure sensors 250, the differential pressure transmitters 136 can be coupled (e.g., connecting, mounting, assembling, electrically coupling, or the like) to both upstream and downstream flow paths to detect a differential pressure between an upstream fluid flow entering a filter and the downstream fluid flow exiting the filter. In some embodiments, in addition to the pressure sensors 250, the differential pressure transmitters 136 can be used.

As shown in FIGS. 2A-2C, the filtration skid 110 with buffer and waste bags 212 and 222 can be designed to support two filtering flow channels, each having a filter. For example, the filtration skid 110 can hold two sterilizing grade filters at the filter position A and filter position B at the same time. If the third and/or fourth filter are needed, filter changes can be performed at the filter position A and filter position B, respectively. In some embodiments, the automation recipe can be filter position related. The automation recipe can be repeated using the filter position A for the third filter and using the filter position B for the fourth filter in the recipe.

FIG. 3 is a diagram illustrating an example product pathway 300 with the filtration system 100 disclosed herein. A portable tank 302 containing a biological product can be connected to the filtration skid 110 via disposable and/or consumable components (e.g., filters, flow path elements, or other suitable components) of the single-use assembly 140. The biological product can be filtered by the filtration skid 110 via the filtration cart 130. The filtered biological product can be dispensed via a transfer line to a filling room 320. As shown in FIG. 3, due to the compact design of the filtration skid 110, the filtration skid 110 can be easily moved to a tank room 310 or wherever they are needed in a biomanufacturing facility.

In some embodiments, the systems disclosed herein (e.g., the filtration skid 110, the single-use assembly 140, the filtration system 100) can be closed systems. A closed system can include unit operations that are designed and operated to limit exposure to the outside environment. Materials may be introduced to a closed system, but the addition must be done in such a way to avoid exposure of the product to the room environment. In some embodiments, the system disclosed herein can include aseptic connectors to create an inline sterile filtration product path at the point of filling.

In some embodiments, the system disclosed herein can include aseptic connections that provide the sterility assurance for the sterilizing grade filters, transfer assemblies, and sample bag(s) in a Grade C area, which minimize the potential contamination from the immediate environment. In some embodiments, the manual pinch clamps provided on the single use assemblies 140 can maintain the sterile barrier when product tanks are not connected yet or disconnected from the single-use assemblies 140. After installation of the single-use assemblies 140 onto the filtration skid 110, a pressure hold test can performed upstream and downstream per automation recipes to detect potential leakage of the filtration system 100 and aseptic connections leakage, and to detect if manual pinch clamps are at the appropriate closed/open position.

The systems described herein can also include a fluid conduit that is disposed between the apparatus and the unit operation. Suitable fluid conduits can be a tube that is made of polyethylene, polycarbonate, or plastic. The fluid conduits can also include one of more of the following in any combination: one or more in-line buffer adjustment reservoirs that are in fluid communication with the fluid conduit and are positioned such that the buffer stored within the in-line buffer adjustment reservoir(s) is added to the fluid present in the fluid conduit; and one or more filters that are disposed in the fluid conduit such that they are capable of filtering (e.g., removing bacteria) the fluid present in the fluid conduit.

In some embodiments, the systems provided herein include a pump system. A pump system can include one or more the following: one or more pumps as known in the art, one or more filters known in the art, and one or more sensors (e.g., one or more temperature sensors, one or more flow sensors, one or more UV detectors, or other suitable sensors).

### Method for Continuous Filtering Process Using Filtration Skid

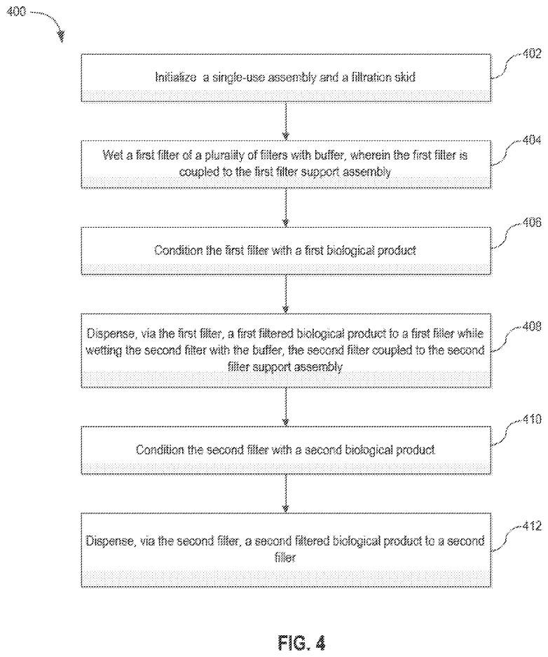

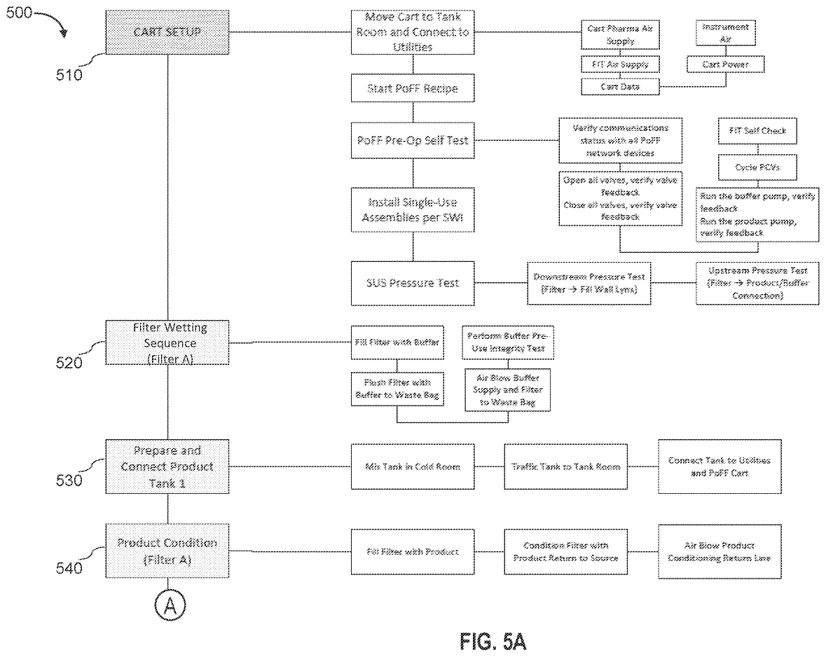

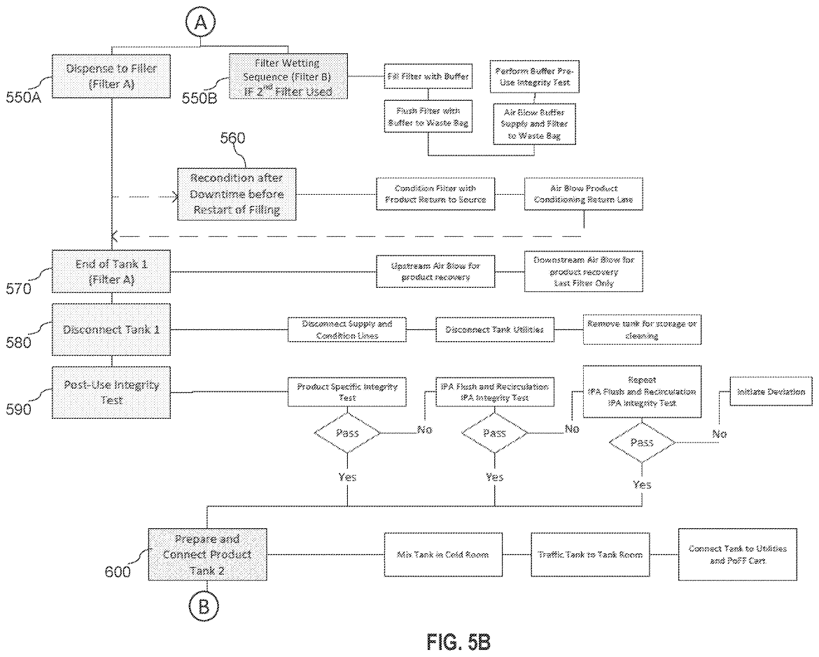

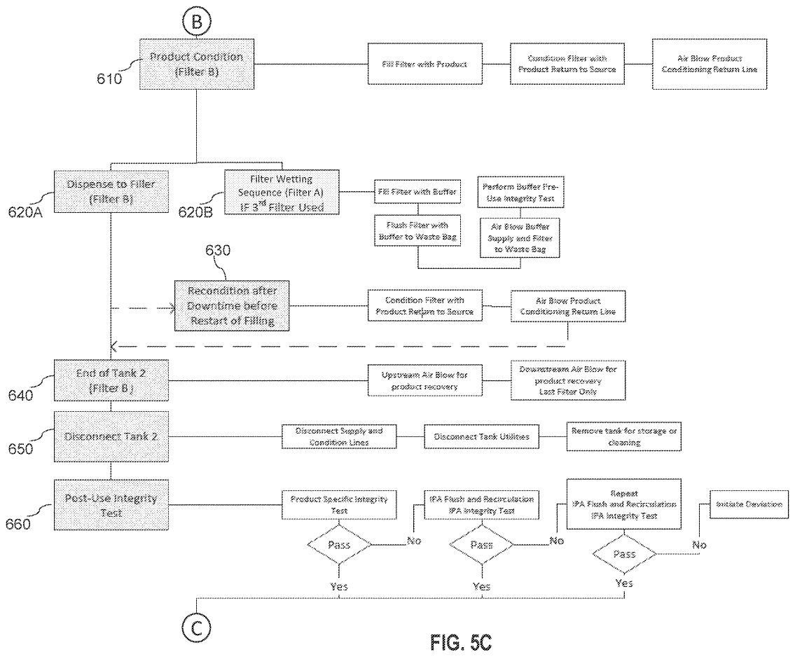

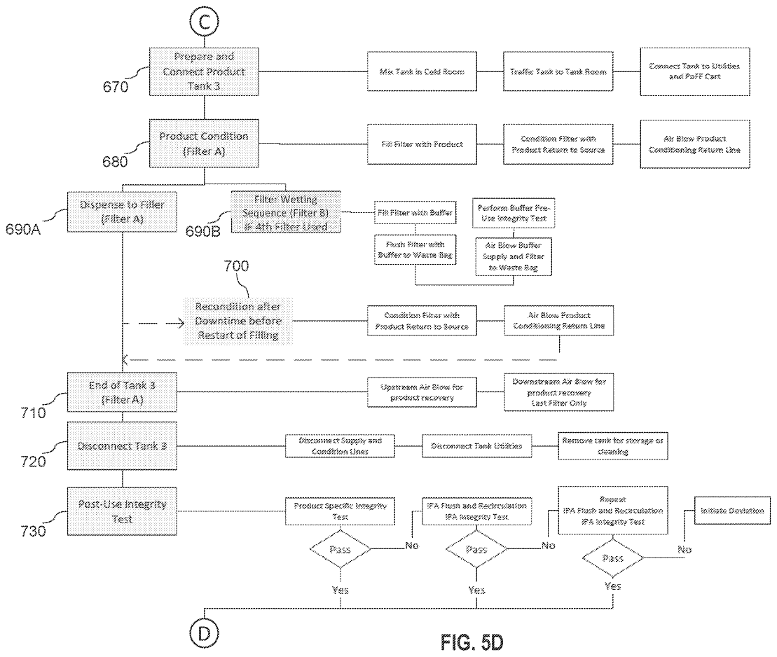

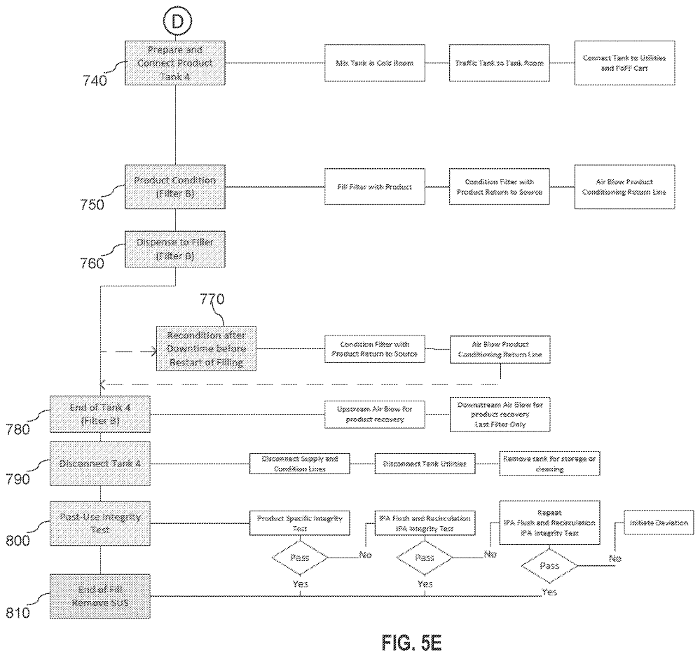

FIG. 4 is a flowchart illustrating continuous filtering process steps 400 carried out by the filtration system 100 of the present disclosure. In step 402, the filtration system 100 can initialize a single-use assembly and a filtration skid. For example, the single-use assembly 140 can be installed into the filtration skid 110. The automation controller 174 can initialize the filtration skid 110 and the single-use assembly 140 using an automation recipe. An automation recipe can include process parameters and/or operating parameters to control one or more hardware components of the filtration skid 110 and the single-use assembly 140 for a specific unit operation and a specific biological product. The single-use assembly 140 can include a plurality of filters. The filtration skid 110 can include a first filter support assembly 131A and a second filter support assembly 131B. Examples of the initialization step are further described in FIG. 5A.

In step 404, the filtration system 100 can wet a first filter of the plurality of filters with buffer. The first filter can be coupled (e.g., connected, attached, mounted or the like) to the first filter support assembly. Examples of the wetting step are further described in FIGS. 5A-5E.

In step 406, the filtration system 100 can condition the first filter with a first biological product. Examples of the wetting step are further described in FIGS. 5A-5E.

In step 408, the filtration system 100 can dispense the first biological product to a first filler after passing through the first filter while wetting the second filter with the buffer. The second filter can be coupled to the second filter support assembly. Examples of the dispensing step are further described in FIGS. 5A-5E.

In step 410, the filtration system 100 can condition the second filter with a second biological product. In some embodiments, the filtration system 100 can allow for preparing and testing of the second filter while dispensing from the first filter. For example, the filtration system 100 can condition the second filter while dispensing the first biological product to the first filler after passing through the first filter. Examples of the conditioning step are further described in FIGS. 5A-5E.

In step 412, the filtration system 100 can dispense the second biological product to a second filler after passing through the second filter. Examples of the dispensing step are further described in FIGS. 5A-5E.

In some embodiments, the filtration system 100 can include only one filler and a common outlet such that the filtered biological product can be dispensed to the filler via the common outlet. The parallel activities can process the biological product through one filter while preparing another filter. For example, the first filler and the second filler are the same filler. In some embodiments, the filtration system can include multiple fillers and multiple outlets, each outlet corresponding to a respective filler. For example, the first and second fillers are different fillers. In some embodiments, the filtration system can include multiple fillers sharing a common outlet. In some embodiments, the first and second biological product can be the same biological product. In some embodiments, the first and second biological product can be different biological products.

In some embodiments, more than two filters can be used in the filtration system 100 for the continuous filtering process. For example, while the filtration system 100 is dispensing the second biological product to the second filter after passing through the second filter, the filtration system 100 can wet a third filter that is coupled to the first filter support assembly. The third filter can be used to filter biological products while the second filter is operating to filter the biological products. In some embodiments, the first biological product and the second biological product can be the same or different. Similarly, a fourth filter can be coupled to the second filter support assembly to filter biological products while the third filter is operating to filter the biological products. In such way, the filtration system 100 can allow continuous filter processing. In some embodiments, the filtration system 100 can include one or more product tanks containing the same biological product to prevent cross contamination. The four filters can be connected to a respective product tank. The output of all the filters can go to a common outlet for filling to a common filler. In some embodiments, the filtration system can include multiple different fillers and multiple outlets, each outlet corresponding to a respective filler. In some embodiments, the filtration system can include multiple fillers sharing a common outlet. In some embodiments, at least one of the product tanks can include a different biological product. At least one filter can filter the different biological product that can be dispensed to a different filler via a particular outlet. Examples for more than two filters are further described in FIGS. 5A-5E.

In some embodiments, parameters of the filter support assemblies can be automatically adjusted for the wetting step, the conditioning step, and the dispensing step. For example, the computing device 150 can execute an automation recipe for a specific step to set, monitor, and adjust process parameters and/or operating parameters associated with the filter support assemblies. In some embodiments, parameters of one filter support assembly can be automatically adjusted while the other filter support assembly is operating. For example, same or different automation recipes can be executed to different support assemblies. While one filter support assembly is operating, a corresponding automation recipe can be executed to automatically adjust process parameters and operating parameters of the other filter support assembly. In some embodiments, the filtration system 100 can automatically adjust parameters of the filter support assemblies to switch biological products from one filtering flow channel to another filtering flow channel (e.g., from one filter to another filter). For example, the filtration system 100 can execute one or more automation recipes to determine flow paths and associated operating and process parameters and to control the operating parameters and/or process parameters to switch the filtering flow channels. Examples of process parameters and operating parameters in automation recipes are further described in FIGS. 6-10.

In some embodiments, the filtration system 100 can determine a differential pressure between an upstream fluid flow entering a filter and a downstream fluid flow exiting the filter. The filtration system 100 can determine whether the differential pressure satisfies a threshold range (e.g., less than or equal to 16 PSI). If the filtration system 100 determines that the differential pressure does not satisfy the threshold range, the filtration system 100 can adjust operating parameters and/or process parameters of the filter support assemblies and/or stop dispensing the operating filter and begin dispensing the biological product through a different filter flow path. The filtration system 100 can further determine an updated differential pressure and send it to the computing device 150 for further analysis based on a feedback control loop. In some embodiments, the filtration system 100 can automatically detect and monitor filter contact time, volume and a differential pressure across each of the first filter and the second filter through filling to ensure the filter contact time, volume and the differential pressure are within a corresponding validated limit. Examples of process parameters, operating parameters and associated thresholds are shown in FIGS. 6-10.

FIGS. 5A-5E are flowcharts illustrating continuous filtering process steps 500 carried out by the filtration system 100 of the present disclosure. In step 510, the filtration skid can be set up. In some embodiments, the filtration skid 100 can be moved to a tank room 310 (shown in FIG. 3) and can be connected to utilities in the tank room 310, such as a cart pharmaceutical air supply, a filter integrity tester air supply, skid power, instrument air, or the like. Data associated with the filtration skid 100 can be also recorded.

The filtration system 100 can start an automation recipe (e.g., Point of Fill Filtration (PoFF) recipe) to initialize the filtration skid 100 and associated utilities.

The filtration system 100 can run a pre-op self test prior to operation. For example The filtration system 100 can verify communications status with all network devices associated with filtration (e.g., PoFF network devices). The filtration system 100 can open all valves, verify valve feedback, close all valves, and verify valve feedback. The filtration system 100 can run the buffer pump 122B and verify its feedback. The filtration system 100 can run the product pump 122A and verify it feedback. The filtration system 100 can cycle proportional control valves (PCVs) that can open a certain percentage between 0-100. This can be used to provide back pressure to the filtration system 100 during one or more unit operations, and then perform a self check for the filter integrity tester 124.

The filtration system 100 can install a single-use assembly 140 and run a pressure test on the single-use assembly 140. The filtration system 100 can perform a downstream pressure test and hen an upstream pressure test.

In step 520, the filtration system 100 can perform a filter wetting sequence for a first filter at the filter position A. For example, the filtration system 100 can fill the first filter with buffer and then flush the first filter with buffer to a waste bag. The filtration system 100 can air blow buffer supply and the first filter to the waste bag. The filtration system 100 can perform a buffer pre-use integrity test using the filter integrity tester 124. In some embodiments, the filtration system 100 can use an automation recipe associated with the filter position A to automatically perform some or all of the steps of the filter wetting step sequence.

In step 530, the filtration system 100 can prepare and connect to a first product tank containing a first biological product. For example, the product tank 302 (shown in FIG. 3) can be mixed in a cold room and moved to the tank room 310. The product tank 310 can be connected to the utilities and the filtration system 100. In some embodiments, the product tank 310 is part of the filtration system 100. The product tank 310 can be connected to the utilities and the filtration skid 110 and the single-use assembly 140.

In step 540, the filtration system 100 can perform a product condition for the first filter. For example, the filtration system 100 can fill the first filter with the first biological product from the first product tank. The filtration system 100 can condition the first filter with a product return to source line. The filtration system 100 can air blow a product conditioning return line. In some embodiments, the filtration system 100 can use an automation recipe associated with the filter position A to automatically perform the product conditioning step.

In step 550A, the filtration system 100 can dispense the first biological product to a first filler after passing through the first filter. The first filler can receive and store the filtered biological product.

In step 550B, if a second filter is used at the filter position B, while the filtration system 100 is dispensing the first biological product to a first filler after passing through the first filter, the filtration system 100 can perform a filter wetting sequence for a second filter at the filter position B. For example, the filtration system 100 can fill the second filter with buffer and then flush the second filter with buffer to the waste bag. The filtration system 100 can air blow buffer supply and the second filter to the waste bag. The filtration system 100 can perform a buffer pre-use integrity test for the second filter using the filter integrity tester 124. In some embodiments, the filtration system 100 can use an automation recipe associated with the filter position A to automatically perform some or all of the steps of the filter wetting sequence and the dispensing step.

In step 560, the filtration system 100 can perform a recondition after downtime before a restart of filling. For example, the filtration system 100 can condition the first filter with a product return to source line. The filtration system 100 can air blow a product condition return line. In some embodiments, the filtration system 100 can use an automation recipe associated with the filter position A to automatically perform the reconditioning step.

In step 570, the filtration system 100 can determine that the end of the first tank is reached. The filtration system 100 can perform an upstream air blow for product recovery. The filtration system 100 can also perform a downstream air blow for product recover for last filter only.

In step 580, the filtration system 100 can disconnect the first tank. For example, the filtration system 100 can disconnect supply and condition lines, tank utilities, and remove the first tank for storage or cleaning.

In step 590, the filtration system 100 can perform a post-use integrity test. For example, the filtration system 100 can perform a product specific integrity test. If the filtration system 100 pass the test, the filtration system 100 can move to step 600. If the filtration system 100 does not pass the test, the filtration system 100 can perform an IPA flush and recirculation IPA integrity test. If the filtration system 100 pass the test, the filtration system 100 can move to step 600. If the filtration system 100 does not pass the test, the filtration system 100 can repeat the IPA flush and recirculation IPA integrity test. If the filtration system 100 pass the test, the filtration system 100 can move to step 600. If the filtration system 100 does not pass the test, the filtration system 100 can automatically or manually initiate a deviation procedure to direct the operator to determine which components of the filtration system 100 cause the failure.

In step 600, the filtration system 100 can direct (via providing instruction) the operator to prepare and connect to a second tank containing a second biological product. For example, the second tank can be mixed in a cold room and moved to the tank room 310. The second tank can be connected to the utilities and the filtration system 100. The first and second biological products can be the same or different.

In step 610, the filtration system 100 can perform a product condition for the second filter. For example, the filtration system 100 can fill the second filter with the second biological product from the second product tank. The filtration system 100 can condition the second filter with a product return to source line. The filtration system 100 can air blow a product conditioning return line. In some embodiments, the filtration system 100 can use an automation recipe associated with the filter position B to automatically perform the product conditioning step.

In step 620A, the filtration system 100 can dispense the second biological product to a second filler after passing through the second filter.

In step 620B, if a third filter is used at the filter position A, while the filtration system 100 is dispensing the second biological product to the second filler after passing through the second filter, the filtration system 100 can perform a filter wetting sequence for the third filter at the filter position A. For example, the filtration system 100 can fill the third filter with buffer and then flush the third filter with buffer to the waste bag. The filtration system 100 can air blow buffer supply and the third filter to the waste bag. The filtration system 100 can perform a buffer pre-use integrity test using the filter integrity tester 124. In some embodiments, the filtration system 100 can use an automation recipe associated with the filter position A to automatically perform some or all of the steps of the filter wetting sequence.

In step 630, the filtration system 100 can perform a recondition after downtime before a restart of filling. For example, the filtration system 100 can condition the second filter with a product return to source line. The filtration system 100 can air blow a product condition return line. In some embodiments, the filtration system 100 can use an automation recipe associated with the filter position B to automatically perform the reconditioning step.

In step 640, the filtration system 100 can determine that the end of the second tank is reached. The filtration system 100 can perform an upstream air blow for product recovery. The filtration system 100 can also perform a downstream air blow for product recover for last filter only.

In step 650, the filtration system 100 can direct the operator to disconnect the second tank. For example, the filtration system 100 can direct the operator to disconnect supply and condition lines, tank utilities, and remove the first tank for storage or cleaning.

In step 660, the filtration system 100 can perform a post-use integrity test. For example, the filtration system 100 can perform a product specific integrity test. If the filtration system 100 pass the test, the filtration system 100 can move to step 670. If the filtration system 100 does not pass the test, the filtration system 100 can perform an IPA flush and recirculation IPA integrity test. If the filtration system 100 pass the test, the filtration system 100 can move to step 670. If the filtration system 100 does not pass the test, the filtration system 100 can repeat the IPA flush and recirculation IPA integrity test. If the filtration system 100 pass the test, the filtration system 100 can move to step 670. If the filtration system 100 does not pass the test, the filtration system 100 can automatically or manually initiate a deviation procedure to direct the operator to determine which components of the filtration system 100 cause the failure.

In step 670, the filtration system 100 can direct the operator to prepare and connect to a third tank containing a third biological product. For example, the third tank can be mixed in a cold room and moved to the tank room 310. The third tank can be connected to the utilities and the filtration system 100. The second and third biological products can be the same or different.

In step 680, the filtration system 100 can perform a product condition for the third filter. For example, the filtration system 100 can fill the third filter with the third biological product from the third product tank. The filtration system 100 can condition the third filter with a product return to source line. The filtration system 100 can air blow a product conditioning return line. In some embodiments, the filtration system 100 can use an automation recipe associated with the filter position A to automatically perform the product conditioning step.

In step 690A, the filtration system 100 can dispense the third biological product to a third filler after passing through the third filter.

In step 690B, if a fourth filter is used at the filter position B, while the filtration system 100 is dispensing the third biological product to the third filler after passing through the third filter, the filtration system 100 can perform a filter wetting sequence for the fourth filter at the filter position B. For example, the filtration system 100 can fill the fourth filter with buffer and then flush the fourth filter with buffer to the waste bag. The filtration system 100 can air blow buffer supply and the fourth filter to the waste bag. The filtration system 100 can perform a buffer pre-use integrity test using the filter integrity tester 124. In some embodiments, the filtration system 100 can use an automation recipe associated with the filter position B to automatically perform some or all of the steps of the filter wetting sequence.

In step 700, the filtration system 100 can perform recondition after downtime before a restart of filling. For example, the filtration system 100 can condition the fourth filter with a product return to source line. The filtration system 100 can air blow a product condition return line. In some embodiments, the filtration system 100 can use an automation recipe associated with the filter position B to automatically perform the reconditioning.

In step 710, the filtration system 100 can determine that the end of the third tank is reached. The filtration system 100 can perform an upstream air blow for product recovery. The filtration system 100 can also perform a downstream air blow for product recover for last filter only.

In step 720, the filtration system 100 can direct the operator to disconnect the third tank. For example, the filtration system 100 can disconnect supply and condition lines, tank utilities, and remove the first tank for storage or cleaning.

In step 730, the filtration system 100 can perform a post-use integrity test. For example, the filtration system 100 can perform a product specific integrity test. If the filtration system 100 pass the test, the filtration system 100 can move to step 740. If the filtration system 100 does not pass the test, the filtration system 100 can perform an IPA flush and recirculation IPA integrity test. If the filtration system 100 pass the test, the filtration system 100 can move to step 740. If the filtration system 100 does not pass the test, the filtration system 100 can repeat the IPA flush and recirculation IPA integrity test. If the filtration system 100 pass the test, the filtration system 100 can move to step 740. If the filtration system 100 does not pass the test, the filtration system 100 can initiate automatically or manually initiate a deviation procedure to direct the operator to determine which components of the filtration system 100 cause the failure.

In step 740, the filtration system 100 can direct the operator to prepare and connect to a fourth tank containing a fourth biological product. For example, the fourth tank can be mixed in a cold room and moved to the tank room 310. The fourth tank can be connected to the utilities and the filtration system 100. The third and fourth biological products can be the same or different.

In step 750, the filtration system 100 can perform a product condition for the fourth filter. For example, the filtration system 100 can fill the fourth filter with the fourth biological product from the fourth product tank. The filtration system 100 can condition the fourth filter with a product return to source line. The filtration system 100 can air blow a product conditioning return line. In some embodiments, the filtration system 100 can use an automation recipe associated with the filter position B to automatically perform the product conditioning step.

In step 760, the filtration system 100 can dispense the fourth biological product to a fourth filler after passing through the fourth filter.

In step 770, the filtration system 100 can perform a recondition after downtime before a restart of filling. For example, the filtration system 100 can condition the fourth filter with a product return to source line. The filtration system 100 can air blow a product condition return line. In some embodiments, the filtration system 100 can use an automation recipe associated with the filter position B to automatically perform the reconditioning step.

In step 780, the filtration system 100 can determine that the end of the fourth tank is reached. The filtration system 100 can perform an upstream air blow for product recovery. The filtration system 100 can also perform a downstream air blow for product recover for last filter only.

In step 790, the filtration system 100 can direct the operator to disconnect the fourth tank. For example, the filtration system 100 can disconnect supply and condition lines, tank utilities, and remove the first tank for storage or cleaning.

In step 800, the filtration system 100 can perform a post-use integrity test. For example, the filtration system 100 can perform a product specific integrity test. If the filtration system 100 pass the test, the filtration system 100 can move to step 810. If the filtration system 100 does not pass the test, the filtration system 100 can perform an IPA flush and recirculation IPA integrity test. If the filtration system 100 pass the test, the filtration system 100 can move to step 810. If the filtration system 100 does not pass the test, the filtration system 100 can repeat the IPA flush and recirculation IPA integrity test. If the filtration system 100 pass the test, the filtration system 100 can move to step 810. If the filtration system 100 does not pass the test, the filtration system 100 can automatically or manually initiate a deviation procedure to direct the operator to determine which components of the filtration system 100 cause the failure.

In step 810, the filtration system 100 can determine that filling is complete and prompt the operator to remove the single-use assembly 140.

In some embodiments, the filtration system 100 can include only one filler and a common outlet such that the filtered biological products can be dispensed to the filler via the common outlet. For example, the first, second, third and fourth filler can be the same filler. In some embodiments, the filtration system can include multiple fillers and multiple outlets, each outlet corresponding to a respective filler. For example, the first, second, third and fourth filler can be different. In some embodiments, the filtration system can include multiple fillers sharing a common outlet. In some embodiments, the first, second, third, and fourth biological products can be the same biological product. In some embodiments, the first, second, third, and fourth biological products can be different biological products.

FIGS. 6A-6C are tables illustrating example Point of Fill Filtration (PoFF) process parameters. FIGS. 6A-6C show example process parameters for each process, associated set point and ranges, and related information. The filtration system 100 can use these example parameters and associated data in the automation recipes for controlling hardware components of the filtration system 100 (e.g., the filtration skid 130, the single-use assembly 140, etc.) and controlling the continuous filtering process described herein (e.g., FIGS. 4 and 5).

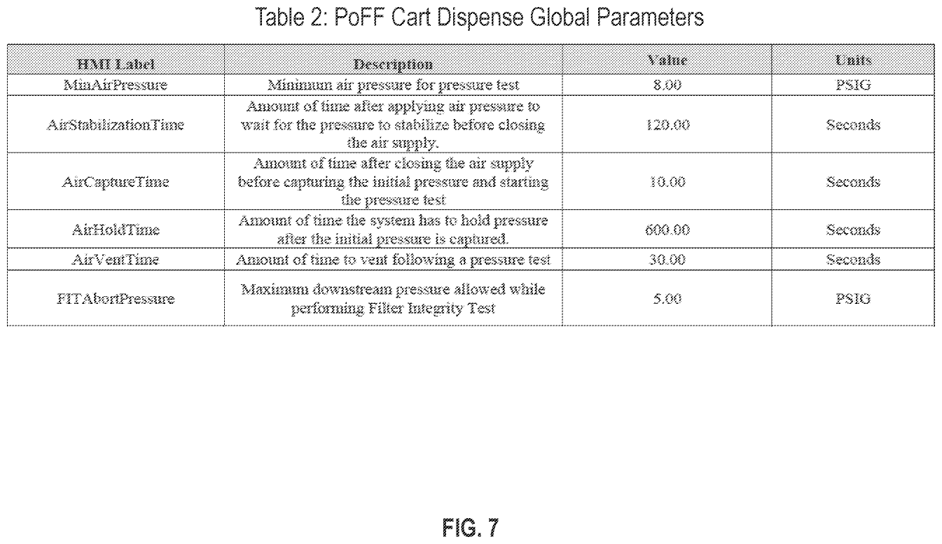

FIG. 7 is a table illustrating example PoFF cart dispense global parameters. The filtration system 100 can use these example parameters and associated data in the automation recipes for controlling hardware components of the filtration system 100 (e.g., the filtration skid 130, the single-use assembly 140, etc.) and controlling the continuous filtering process described herein (e.g., FIGS. 4 and 5).

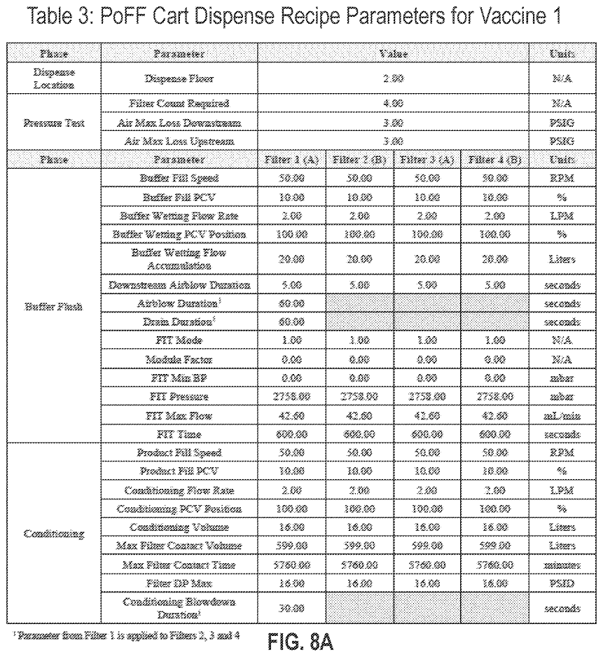

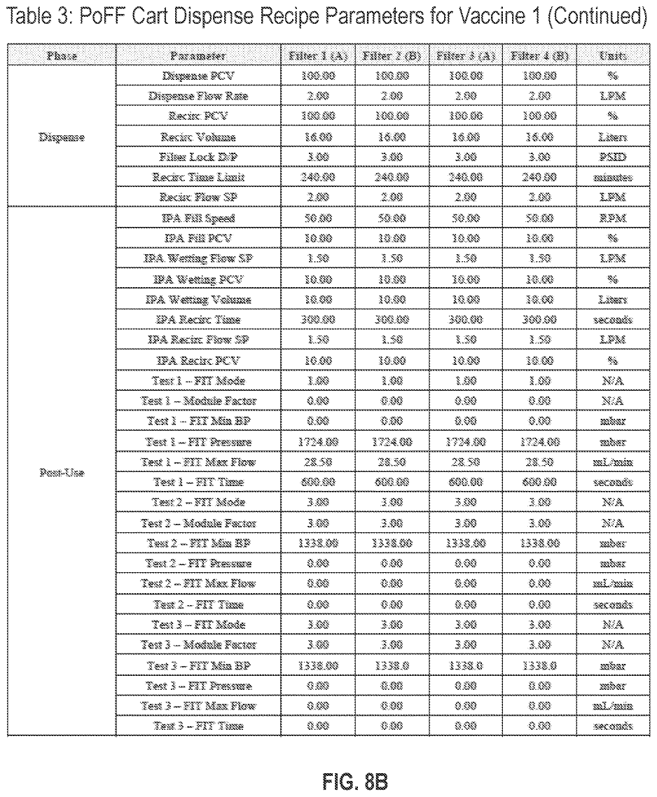

FIGS. 8A and 8B are tables illustrating example PoFF cart dispense recipe parameters for an example vaccine. The filtration system 100 can use these example parameters and associated data in the automation recipes for controlling hardware components of the filtration system 100 (e.g., the filtration skid 130, the single-use assembly 140, etc.) and controlling the continuous filtering process described herein (e.g., FIGS. 4 and 5).

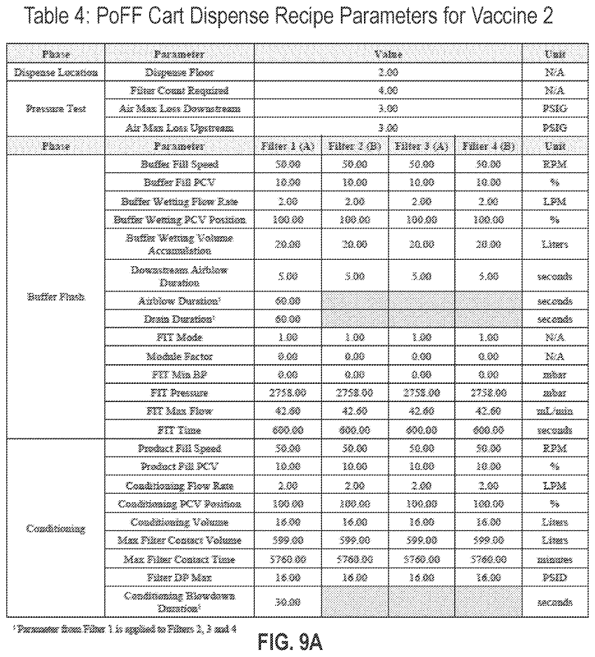

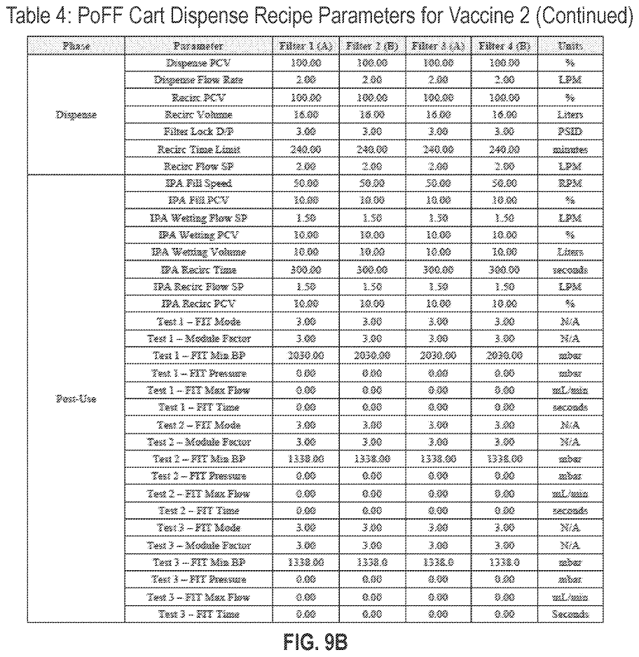

FIGS. 9A and 9B are tables diagrams illustrating example PoFF cart dispense recipe parameters for another example vaccine. The filtration system 100 can use these example parameters and associated data in the automation recipes for controlling hardware components of the filtration system 100 (e.g., the filtration skid 130, the single-use assembly 140, etc.) and controlling the continuous filtering process described herein (e.g., FIGS. 4 and 5).

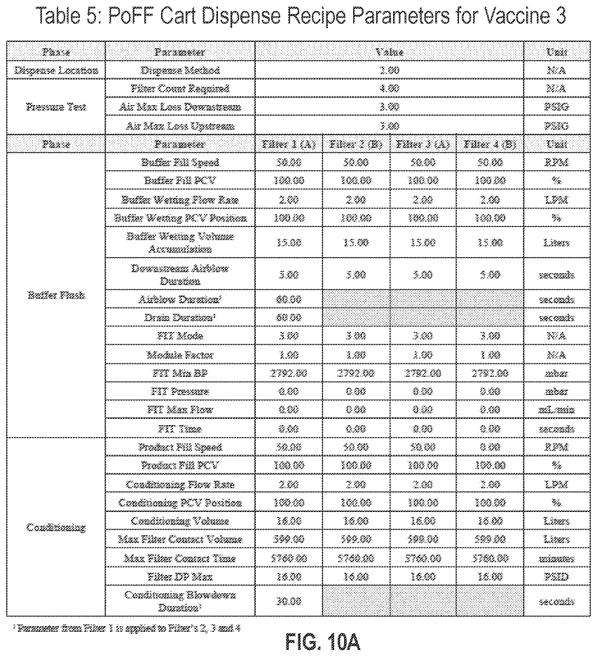

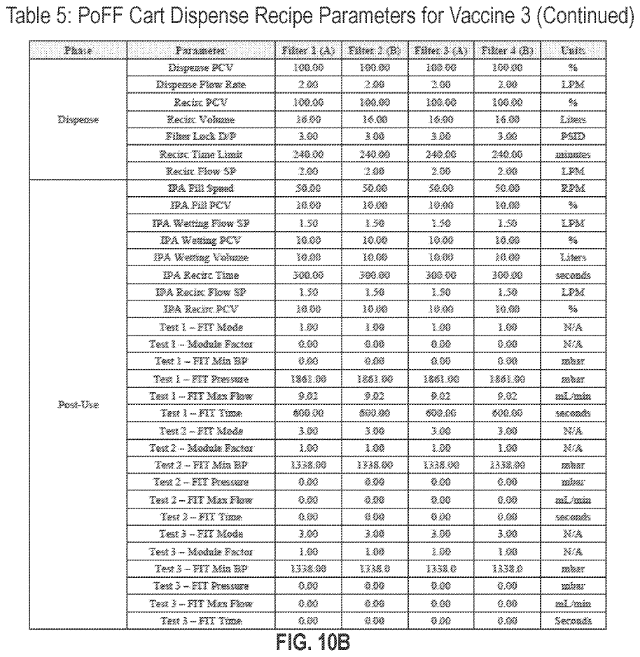

FIGS. 10A and 10B are tables illustrating example PoFF cart dispense recipe parameters for another example vaccine. The filtration system 100 can use these example parameters and associated data in the automation recipes for controlling hardware components of the filtration system 100 (e.g., the filtration skid 130, the single-use assembly 140, etc.) and controlling the continuous filtering process described herein (e.g., FIGS. 4 and 5).

It should be understood that parameters used in the filtration system 100 can be specific to biological products. Different parameters can be used for different biological products. It should be also understood that values listed in FIGS. 6-10 are examples for illustration.

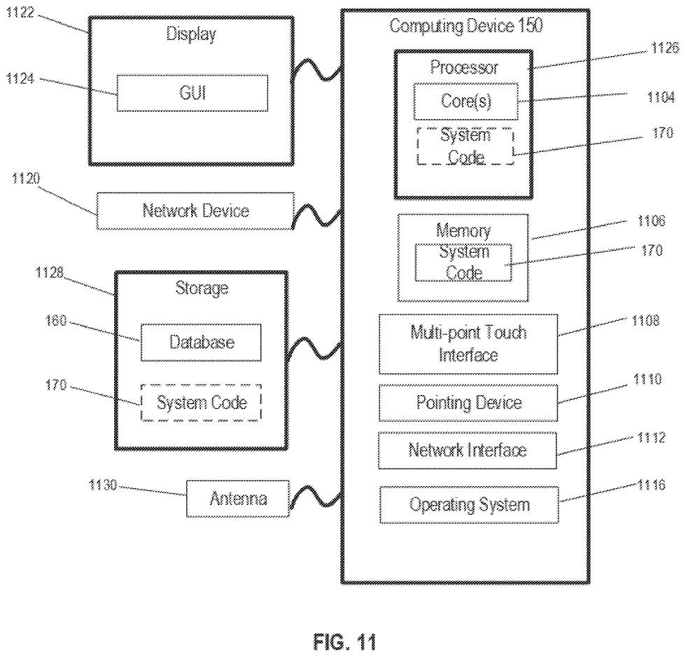

FIG. 11 is a diagram of an example computing device 150 that can be used to perform one or more steps of the methods provided by example embodiments. The computing device 150 includes one or more non-transitory computer-readable media for storing one or more computer-executable instructions or software for implementing example embodiments. The non-transitory computer-readable media can include, but are not limited to, one or more types of hardware memory, non-transitory tangible media (for example, one or more magnetic storage disks, one or more optical disks, one or more USB flashdrives), and the like. For example, memory 1106 included in the computing device 150 can store computer-readable and computer-executable instructions or software for implementing example embodiments (e.g., the system code 170). The computing device 150 also can include the processor 1126 and associated core 1104, for executing computer-readable and computer-executable instructions or software stored in the memory 1106 and other programs for controlling system hardware. The processor 1126 can be a single core processor or multiple core (1104) processor.

Memory 1106 can include a computer system memory or random access memory, such as DRAM, SRAM, EDO RAM, and the like. The memory 1106 can include other types of memory as well, or combinations thereof. A user can interact with the computing device 150 through the display 1122, such as a touch screen display or computer monitor, which can display the graphical user interface (GUI) 1124. The display 1122 can also display other aspects, transducers and/or information or data associated with example embodiments. The computing device 150 can include other I/O devices for receiving input from a user, for example, a keyboard or any suitable multi-point touch interface 1108, a pointing device 1110 (e.g., a pen, stylus, mouse, or trackpad). The keyboard 1108 and the pointing device 1110 can be coupled to the visual display device 1122. The computing device 150 can include other suitable conventional I/O peripherals.

The computing device 150 can also include one or more storage devices 1128, such as a hard-drive, CD-ROM, or other computer readable media, for storing data and computer-readable instructions, applications, and/or software that implements example operations/steps of the filtration system 100 as described herein, or portions thereof, which can be executed to generate GUI 1124 on display 1122. Example storage devices 1128 can also store one or more databases 160 for storing any suitable information required to implement example embodiments. The databases 160 can be updated by a user or automatically at any suitable time to add, delete or update one or more items in the databases. Example storage device 1128 can store one or more databases 160 for storing provisioned data, and other data/information used to implement example embodiments of the systems and methods described herein.

The computing device 150 can include a network interface 1112 configured to interface via one or more network devices 1120 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 1112 can include a built-in network adapter, network interface card, PCMCIA network card, card bus network adapter, wireless network adapter, USB network adapter, modem or any other device suitable for interfacing the computing device 150 to any type of network capable of communication and performing the operations described herein. Moreover, the computing device 150 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 150 can run any operating system 1116, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In some embodiments, the operating system 1116 can be run in native mode or emulated mode. In some embodiments, the operating system 1116 can be run on one or more cloud machine instances.

The computing device 150 can also include an antenna 1130, where the antenna 1130 can transmit wireless transmissions a radio frequency (RF) front end and receive wireless transmissions from the RF front end.

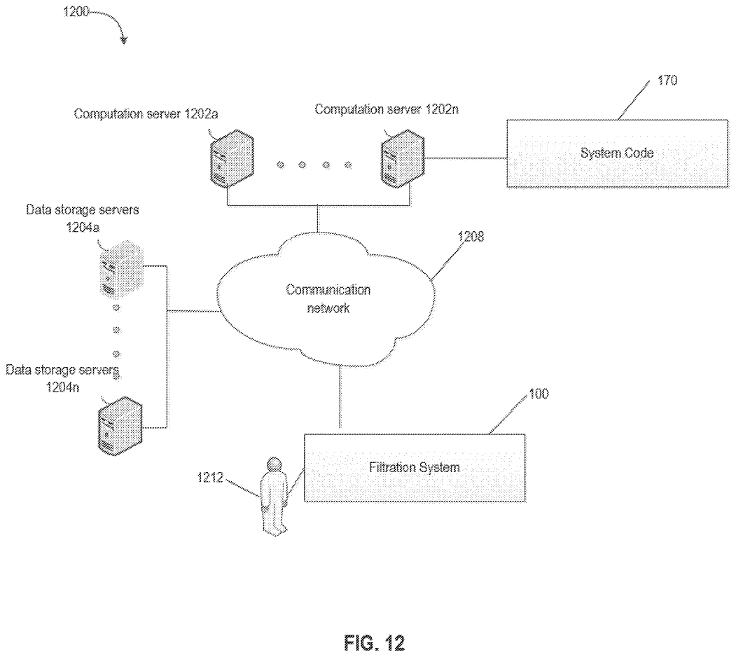

FIG. 12 is a diagram illustrating computer hardware and network components on which the system 1200 can be implemented. The system 1200 can include the filtration system 100, a plurality of computation servers 1202a-1202n having at least one processor (e.g., one or more graphics processing units (GPUs), microprocessors, central processing units (CPUs), tensor processing units (TPUs), application-specific integrated circuits (ASICs), etc.) and memory for executing the computer instructions and methods described above (which can be embodied as system code 170). The system 1200 can also include a plurality of data storage servers 1204a-1204n for storing data. The computation servers 1202a-1202n, the data storage servers 1204a-1204n, and the filtration system 100 accessed by a user 1212 can communicate over a communication network 1208.

It should be understood that the operations and processes described above and illustrated in the figures can be carried out or performed in any suitable order as desired in various implementations. Additionally, in certain implementations, at least a portion of the operations can be carried out in parallel. Furthermore, in certain implementations, less than or more than the operations described can be performed.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes multiple system elements, device components or method steps, those elements, components or steps may be replaced with a single element, component or step. Likewise, a single element, component or step may be replaced with multiple elements, components or steps that serve the same purpose. Moreover, while example embodiments have been shown and described with references to particular embodiments thereof, those of ordinary skill in the art will understand that various substitutions and alterations in form and detail may be made therein without departing from the scope of the present disclosure. Further still, other embodiments, functions and advantages are also within the scope of the present disclosure.

What is claimed is:

1. A filtration system for filtering one or more biological products, comprising:
a filtration skid configured for engagement with components of a single-use assembly for facilitating one or more unit operations of a continuous filtering process for the one or more biological products, the filtration skid comprising a pump cart and a filtration cart, the filtration cart comprising:
a first filter support assembly configured to support a first filtering flow channel; and
a second filter support assembly configured to support a second filtering flow channel.

2. The filtration system of claim 1, further comprising:
a memory storing one or more instructions;
a processor configured to or programmed to execute the one or more instructions stored in the memory, the processor configured to:
automatically adjust parameters of the second filter support assembly for filtering a biological product of the one or more biological product while the first filter support assembly is filtering the same or a different biological product of the one or more biological product.

3. The filtration system of claim 1, wherein the pump cart and the filtration skid cart are built into a single cart.

4. The system of claim 1, wherein the processor is further configured to:
automatically adjust parameters of the first filter support assembly and the second filter support assembly to automatically switch a fluid flow between the first filtering flow channel and the second filtering flow channel.

5. The system of claim 1, wherein each of the first filter support assembly and the second filter support assembly comprises a support, a plurality of automated valves, a plurality of sensors, and a plurality of transmitters.

6. The system of claim 5, wherein the plurality of sensors comprise a first pressure sensor configured to detect upstream pressure to a fluid flow entering a respective filter, and a second pressure sensor configured to detect downstream pressure to the fluid flow exiting the respective filter.

7. The system of claim 5, wherein the processor is further configured to calculate a differential pressure based at least in part on the upstream pressure and the downstream pressure.

8. The system of claim 5, wherein the plurality of automated valves comprise automated pinch valves.

9. The system of claim 1, wherein the pump cart comprises one or more pumps, a filter integrity tester, a plurality of air filters, a plurality of automated valves, a plurality of sensors, and a plurality of transmitters.

10. The system of claim 1, wherein one or more components of the first filter support assembly and the second filter support assembly are reusable.

11. The system of claim 1, wherein the single-use assembly comprises a plurality of consumable and/or disposable components.

12. The system of claim 1, wherein the unit operations comprise one or more functional steps or one or more system components for preforming depth filtration, sterile filtration, or viral filtration.

13. A method for a continuous filtering process using a filtration skid comprising:
initializing a single-use assembly and a filtration skid, wherein the single-use assembly comprises a plurality of filters, the filtration skid comprises a first filter support assembly and a second filter support assembly;
wetting a first filter of the plurality of filters with buffer, wherein the first filter is coupled to the first filter support assembly;
conditioning the first filter with a first biological product;
dispensing the first biological product to a first filler after passing through the first filter while wetting a second filter of the plurality of the filters with the buffer, the first filler receiving a first filtered biological product from the first filter, the second filter coupled to the second filter support assembly;
conditioning the second filter with a second biological product; and
dispensing the second biological product to a second filler after passing through the second filter.

14. The method of claim 13, further comprising automatically adjusting parameters of the first filter support assembly during wetting, conditioning, or dispensing.

15. The method of claim 13, further comprising automatically adjusting parameters of the second filter support assembly while dispensing the first biological product after passing through the first filter.

16. The method of claim 13, further comprising wetting a third filter of the plurality of filters while dispensing the second biological product to the second filler.

17. The method of claim 16, further comprising automatically adjusting parameters of the first filter support assembly and the second filter support assembly to switch the second biological product from the second filter to the third filter.

18. The method of claim 13, wherein the first biological product and the second biological product are the same.

19. The method of claim 13, further comprising:
determining a differential pressure between an upstream fluid flow entering a respective filter and a downstream fluid flow exiting the respective filter; and
adjusting parameters of the first filter support assembly and the second filter support assembly based at least in part on determining whether the differential pressure satisfies a threshold range.

20. The method of claim 13, further comprising:
performing pre-use integrity test prior to a connection to a biological product tank;
performing post-use integrity test after a disconnection to the biological product tank.

21. The method of claim 13, wherein the first biological product or the second biological product comprises vaccines.

22. The method of claim 13, wherein the plurality of filters comprise one or more sterilizing grade filters.
